(19) United States
(12) Patent Application Publication
(10) Pub. No.: US 2003/0058860 A1
(43) Pub. Date: Mar. 27, 2003

(54) Destination address filtering

(76) Inventors: Aaron R. Kunze, Portland, OR (US); Erik J. Johnson, Portland, OR (US); John A. Wiegert, Hillsboro, OR (US)

Correspondence Address: FISH & RICHARDSON, PC, 4350 LA JOLLA VILLAGE DRIVE, SUITE 500, SAN DIEGO, CA, 92122, US

(21) Appl. No.: 09/965,514

(22) Filed: Sep. 25, 2001

(51) Int. Cl. H04L 12/56

(52) U.S. Cl. 370/392; 370/401

(57) ABSTRACT

A destination address routing data structure may be loaded with non-forwarding destination addresses such that a lookup performed with the routing data structure using one of the non-forwarding destination addresses may result in identification of a packet as one to be dropped.

### BACKGROUND

The present application describes systems and techniques relating to destination address filtering, for example, filtering of packets with non-forwarding destination addresses at an inter-networking layer of a computer networking protocol, such as Internet Protocol (IP).

A computer network is a collection of nodes coupled together with wired or wireless communication links, such as coax cable, fiber optics or radio frequency bands. Each node is capable of communicating with other nodes over the communication links using networking protocols. A node may be any machine capable of communicating using the network protocol.

Many computer networks use packet switching in which, when data is to be sent over the network, it is first broken up into segments known as packets or datagrams, and each packet is handled separately. Each data packet typically includes a header with routing information such as a source address and a destination address. These addresses uniquely identify the source node and the destination node for the data packet.

An inter-network is a collection of computer networks coupled together by routers (also known as gateways) and an inter-networking protocol. FIG. 1 is a block diagram illustrating a typical operational environment for a router 115. The router 115 connects two or more networks (or subnets) 110 with each other. Each network 110 includes at least one host capable of communicating using the inter-networking protocol.

Thus, the router 115 effectively connects each network 110 with a broader inter-network 105, and multiple network access devices 100 may communicate with each other, regardless of their particular networking technology. Examples of inter-networks include the Internet, intranets, etc. The addressing system used by the Internet allows routing of packets based upon a destination network as well as a destination host.

Typically, packets are routed through the Internet using lookup tables stored in random access memory (PAM). As each packet is received, its destination address is first checked against known non-forwarding addresses (i.e. destination addresses that are invalid for packets traveling between networks), and then the destination address is processed using a lookup table to identify a next-hop route.

### DRAWING DESCRIPTIONS

FIG. 1 is a block diagram illustrating a typical operational environment for a router.

FIG. 2 is a flowchart of a procedure for routing a packet in a typical Internet router.

FIG. 3 is a logic flow diagram of a procedure for initializing a route table and for routing packets in an inter-networking router.

FIGS. 4A and 4B are a block diagram showing details of an example route table.

FIG. 5 is a block diagram illustrating an example computing environment.

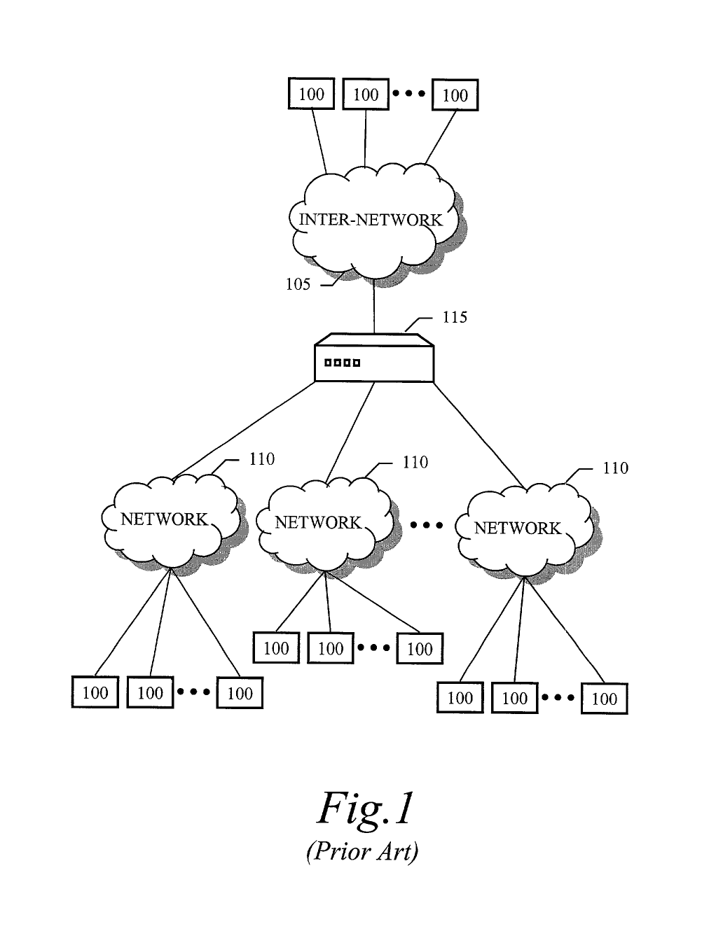

Details of one or more embodiments are set forth in the accompanying drawings and the description below. Other features and advantages will be apparent from the description and drawings, and from the claims.

### DETAILED DESCRIPTION

The systems and techniques described here relate to handling packets with non-forwarding destination addresses. The description that follows discusses packet handling in the context of IP, but may apply equally in other contexts, for example to any networking protocol that allows forwarding of packets based upon part of a destination address and which includes non-forwarding destination addresses (e.g., illegal addresses, loopback addresses, reserved addresses, deprecated broadcast addresses, etc.).

The present inventors recognized that conventional routers and routing software tended to spend excessive time checking destination addresses of incoming packets against non-forwarding destination addresses (e.g., checking for deprecated directed broadcast addresses in an IP router) before proceeding to an address lookup in a router table. Accordingly, the inventors developed destination address filtering systems and techniques that handle non-forwarding destination addresses within a routing data structure used in packet routing. Implementations of the destination address filtering systems and techniques may include various combinations of the following features.

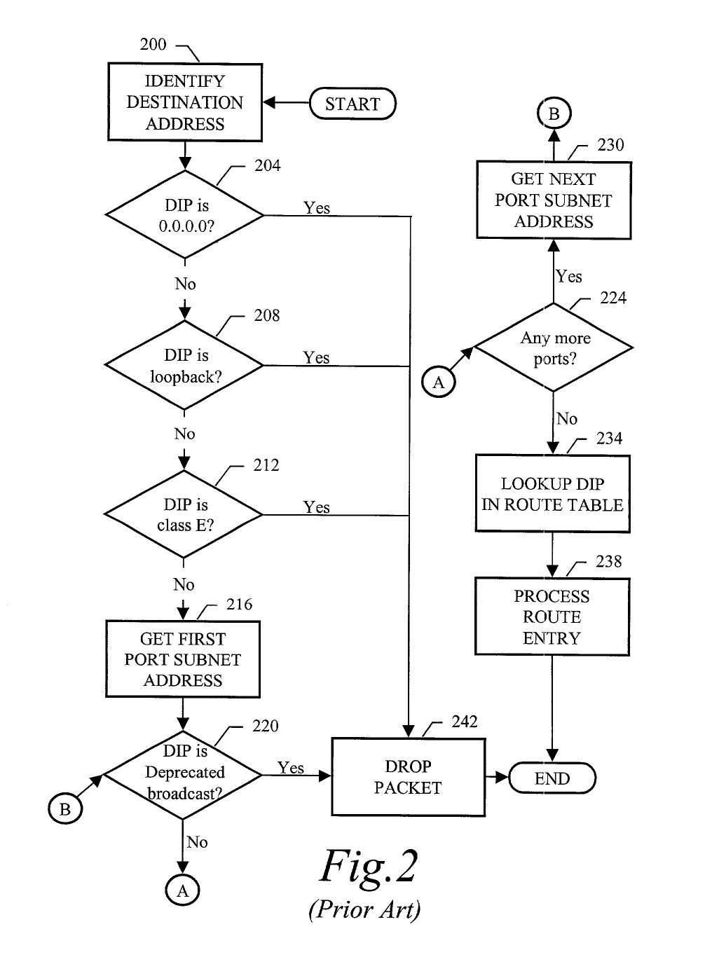

FIG. 2 is a flowchart of a procedure for routing a packet in a typical Internet router. Each time a packet is received, the process begins at block 200, in which the packet's destination address is identified. Following this, each non-forwarding address is checked in turn to determine if the packet should be dropped.

For example, in block 204, the destination IP address (DIP) is confirmed to be non-zero. In block 208, the DIP is confirmed as not the loopback address {127,*} (i.e. a destination address that must not appear outside a host). In block 212, the DIP is confirmed as not a Class E address {240,*} to {247,*}. In blocks 216, 220, 224 and 230, the DIP is confirmed as not a deprecated directed broadcast address {subnet prefix, 0}. If the DIP is found to be any of these non-forwarding addresses, the packet is dropped in block 242.

If the packet does not have a non-forwarding DIP, the DIP is looked up in the route table in block 234. Then the route entry found in block 234, which may be a default route entry, is processed in block 238.

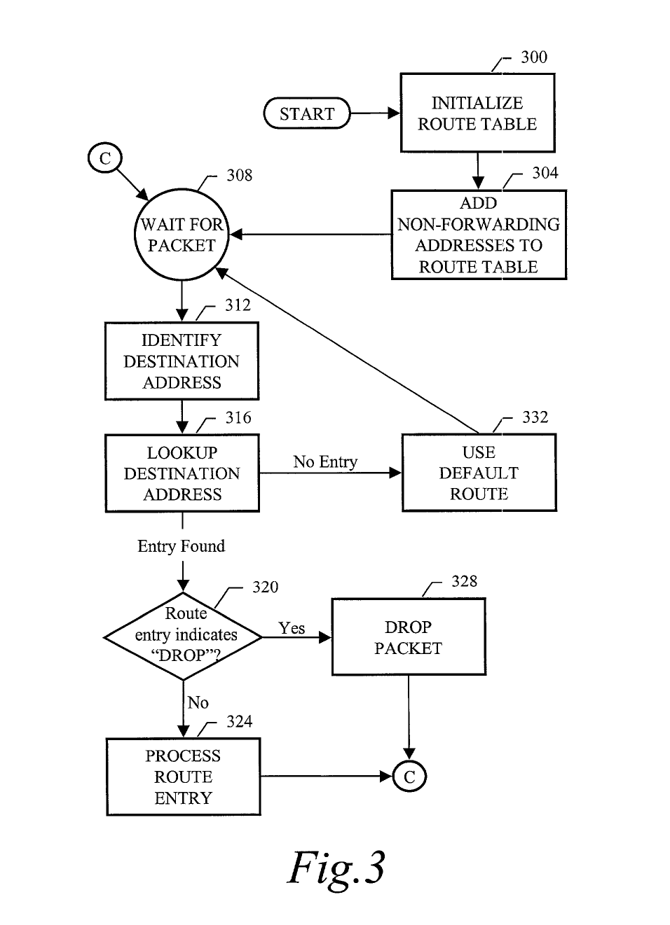

FIG. 3 is a logic flow diagram of a procedure for initializing a route table and for routing packets in an inter-networking router. The procedure begins at block 300, in which a route table is initialized. Generally, initializing a route table involves identifying a router's own IP address and placing a default route entry into the route table or other appropriate data structure. However, block 300 may also include loading of various IP addresses and/or portions of IP addresses into the route table along with loading of corresponding route entries.

The data that is loaded in block 300 may be retrieved from long-term storage, such as a hard disk, or it may be obtained in other ways. For example, in a diskless router, a Reverse Address Resolution Protocol (RARP) or a bootstrap protocol may be used to determine the router's own IP address in block 300. In addition, the Internet Control Message Protocol (ICMP) redirect command may also be used in block 300 to install initial routes.

Following block 300, non-forwarding addresses are added to the route table in block 304. The route entry for each such non-forwarding address includes an indication that a packet with this destination address should be dropped. There may be multiple such route entries or only one such route entry.

The non-forwarding destination addresses may be static or dynamic. For example, some non-forwarding destination addresses will depend on the subnets on which the router has ports. In an IP router implementation, the non-forwarding destination addresses may be any of the illegal addresses described in Internet Engineering Task Force's Request For Comment (RFC) 1812 [Baker 1995], which specifies requirements for an IP router.

Following block 304, the procedure enters a route table management state 308. In state 308, maintenance functions are performed, and the router waits for a new packet to be received. For example, state 308 may include starting a routing daemon, which handles updates to the routing table in the background. Likewise, state 308 may include management of an incoming packet queue.

Once a new packet is received or taken out of a packet queue, control passes to block 312, in which the destination address is identified. For example, a destination address field as defined by the network protocol being used may be read from the packet, and the destination address placed in a specific memory location for further processing. The destination address field is 32 bits long in IP version 4 and 128 bits long in IP version 6.

Then, the destination address is checked against the route table in block 316. Other types of packet-routing data structures may be used in place of a route table. The result of the address lookup in block 316 is either that a route entry is found or not.

If no route entry is found, control passes to block 332 in which a default route is used for the packet. Then, the procedure returns to state 308.

If a route entry is found in block 316, control passes to block 320 in which the identified route entry is checked to see if the route entry includes an indication that the packet should be dropped. For example, the route entry may have a DROP flag, which if set, indicates that this packet has a non-forwarding destination address. If the route entry indicates the packet is to be dropped, control passes to block 328 in which the packet is dropped and then the procedure returns to state 308.

If the route entry does not indicate the packet should be dropped, control passes to block 324 in which the packet is processed according to the information stored in the identified route entry. The processing of block 324 may include the typical packet routing carried out by routers. After block 324, the procedure returns to state 308.

Alternatively, the indication that the packet should be dropped may be a network interface in the route entry that causes the packet to be dropped when routed. Thus, blocks 320 and 328 may be unnecessary, and control may pass directly to block 324 when a route entry is found in block 316.

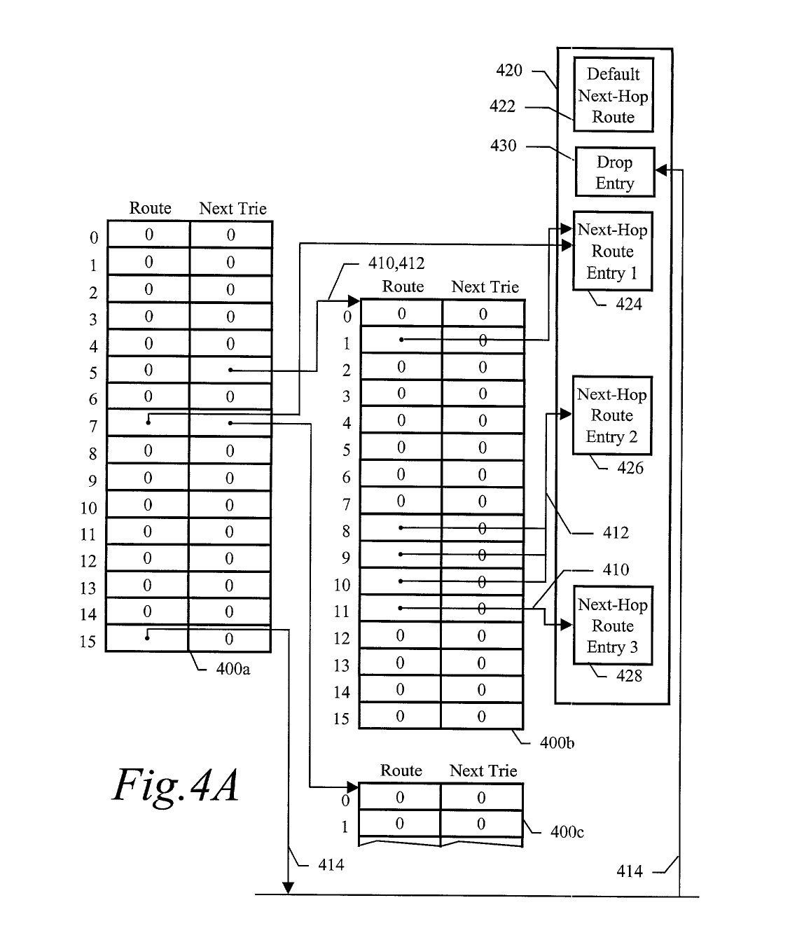

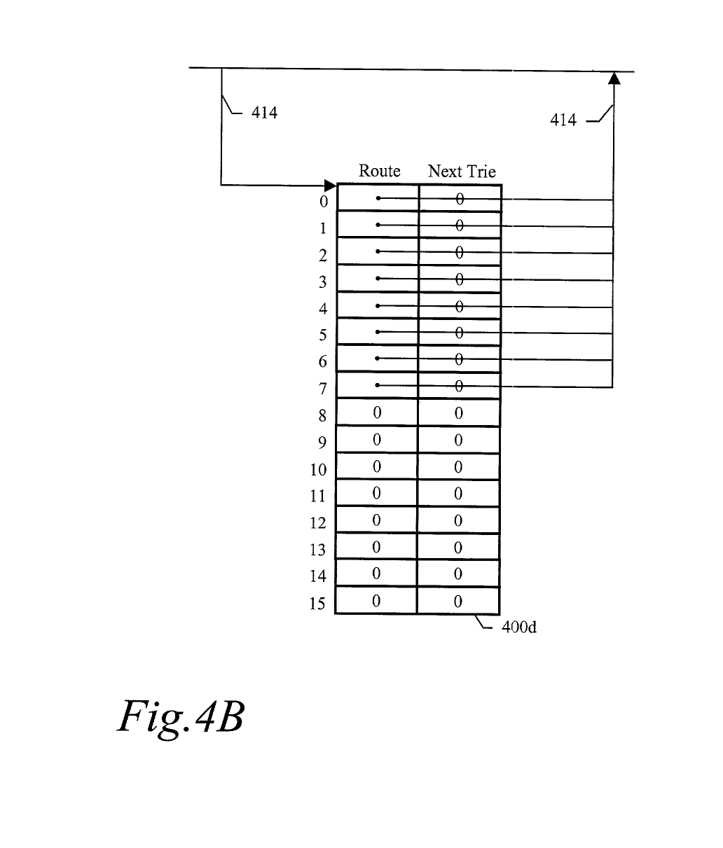

FIGS. 4A and 4B are a block diagram showing details of an example route table. Other route tables and other types of data structures may be used for looking up routing information, and may be preferable depending upon routing speed requirements, memory limitations and/or system designer preferences. The route table is made up of trie blocks 400a, 400b, 400c, 400d, which will be referred to generally as trie blocks 400.

Each trie block 400 is an array of entries indexed by a portion of the destination address of an incoming packet. The trie block entries may contain a pointer to a route entry, a pointer to another trie, or both. If all the trie blocks are stored in a single array, the trie pointers may be indexes into the trie array.

Each trie block 400 contains sixteen entries. Thus, a lookup algorithm operating on the trie blocks 400 considers destination addresses four bits at a time. However, many different lookup table structures and corresponding algorithms may be possible. For example, in a 32-bit address space, the first set of bits considered by the algorithm may be as few as one bit or as many as 31 bits.

In addition to the trie blocks 400, various side structures may be maintained in memory (e.g., SDRAM (Synchronous Dynamic Random Access Memory)) for use in performing route adds and deletes. These various side structures, which typically are not used in lookups, may include an array of masks, an array of next trie pointers and three prefix arrays for each trie block 400.

Each mask array holds bit-masks indicating the prefix length of the route for the route pointer installed in the associated trie entry. When a route is added to a trie block 400, the bit-mask is used to determine whether or not to overwrite a route pointer. If the bit-mask for the route being added is longer (i.e. more ones in the bit-mask) than the route already existing in a particular trie entry, then the new route entry replaces the old. Otherwise, no changes are made.

Each array of next trie pointers contains pointers that point to the side structures for the next trie block, as opposed to the next trie block. This structure allows for lookup traversal of the trie block structure during route adds and deletes.

The prefix side structures hold route indexes and are indexed by the masked bits of the destination address of a route. There may be three prefix arrays for each prefix side structure: prefix-1, prefix-2, and prefix-3. The ‘n’ in prefix-n indicates how many ones are in the mask. These structures are used to determine which less specific route should be installed when a more specific one is deleted.

The number of trie blocks used in any particular lookup is determined by how long the prefixes are in the routes installed in the route table. For example, an eight-bit prefix route takes up two trie blocks 400. An eight-bit prefix route 410 is installed in entry five of trie block 400a and entry eleven of trie block 400b. The eight-bit prefix route 410 has a destination address of 0x5b000000 and a mask of 0xff000000, and points to next-hop route entry three 428.

Due to the use of masks as described above, more and less specific routes may be stored in the same trie block 400. For example, a six-bit prefix route 412 has a destination address of 0x58000000 and a mask of 0xfc000000. If route 410 were deleted, a new pointer would be added to entry eleven of trie block 400b, and this new pointer would point to next-hop route entry two 426.

Next-hop route entries 422, 424, 426, 428 contain information used in forwarding a packet onto a particular next-hop router or host. This information may include an outgoing interface number and the next-hop IP address in an IP implementation. The next-hop route entries 422, 424, 426, 428 may also contain extra information, such as the MTU (Message Transfer Unit) of the outgoing interface, various flags, Address Resolution Protocol (ARP) information, reference count, and allocation information. This extra information allows the lookup algorithm to directly patch the packet and forward it once the route lookup has been performed. Multiple router pointers in the trie blocks 400 may use the same next-hop route entry, and the allocation of next-hop route entries may be strictly managed.

The next-hop route entries 422, 424, 426, 428 and a default next-hop route entry 422 may be stored in a single array 420. In this type of implementation, entry zero in the next-hop array 420 may be reserved for the default next-hop route entry 422, which stores the default route to be used if no other route in the route table matches the destination address of a packet. If the interface number in the default next-hop route entry 422 is negative one, this indicates that there is no default route.

The next-hop array 420 may also contain a drop entry 430 that includes a flag indicating that the packet should be dropped. A lookup that resolves to the drop entry 430 indicates that the packet has a non-forwarding destination address and is to be dropped, possibly after appropriate recording of tracking information, such as source and destination address, and incrementing of a dropped-packets counter.

For example, if a packet has a Class E destination IP address, the lookup will result in route 414, which points to the drop entry 430. Route 414 is a five-bit prefix route with a destination address of 0xf00000000 and a mask of 0xf8000000.

Alternatively, no drop entry 430 is used. For example, a route pointer of twos compliment negative one may be used to indicate that the packet should be dropped. In this implementation, once the final trie block 400 is found during resolution of a destination address, the routing portion of the trie block entry is first checked to see if it is non-zero. If it is zero, then either a previously identified route (i.e. from a trie block higher in the trie block tree) is used or the default route is used if present.

If the routing portion of the trie block entry is non-zero, then its compliment is checked to see if it is zero. If the compliment is zero, then the packet contains a non-forwarding destination address and should be dropped. If the compliment is non-zero, then the routing portion of the trie block entry contains a pointer to a next-hop route entry, which should be used to forward the packet.

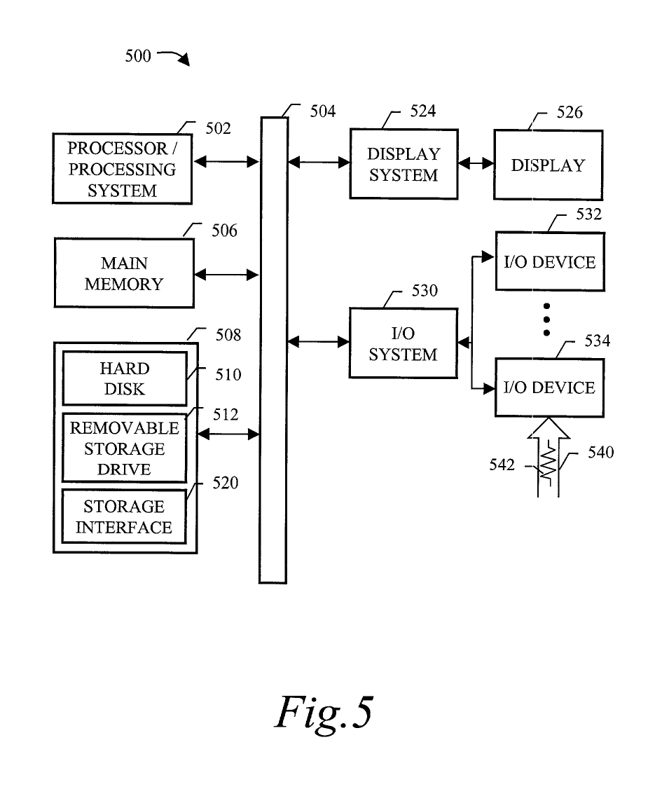

FIG. 5 is a block diagram illustrating an example computing environment. An example machine 500 includes a processing system 502, which may include a central processing unit such as a microprocessor or microcontroller for executing programs to control tasks in the machine 500, thereby enabling the features and function described above. Moreover, the processing system 502 may include one or more additional processors, which may be discrete processors or may be built in to the central processing unit.

The processing system 502 is coupled with a bus 504, which provides a set of signals for communicating with the processing system 502 and may include a data channel for facilitating information transfer between storage and other peripheral components of the machine 500.

The machine 500 may include embedded controllers, such as Generic or Programmable Logic Devices or Arrays (PLD, PLA, GAL, PAL), Field Programmable Gate Arrays (FPGA), Application Specific Integrated Circuits (ASIC), single-chip computers, smart cards, or the like, which may serve as the processing system 502.

The machine 500 may include a main memory 506 and one or more cache memories, and may also include a secondary memory 508. These memories provide storage of instructions and data for programs executing on the processing system 502, and may be semiconductor based and/or non-semiconductor based memory. The secondary memory 508 may include, for example, a hard disk drive 510, a removable storage drive 512 and/or a storage interface 520.

The machine 500 may also include a display system 524 for connecting to a display device 526. The machine 500 includes an input/output (I/O) system 530 (i.e., one or more controllers or adapters for providing interface functions) for connecting to one or more I/O devices 532-534. The I/O system 530 may provide a communications interface, which allows software and data to be transferred, in the form of signals 542, between machine 500 and external devices, networks or information sources. The signals 542 may be any signals (e.g., electronic, electromagnetic, optical, etc.) capable of being received via a channel 540 (e.g., wire, cable, optical fiber, phone line, infrared (IR) channel, radio frequency (RF) channel, etc.). A communications interface used to receive these signals 542 may be a network interface card designed for a particular type of network, protocol and channel medium, or may be designed to serve multiple networks, protocols and/or channel media.

Machine-readable instructions (also known as programs, software or code) are stored in the machine 500 and/or are delivered to the machine 500 over a communications interface. As used herein, the term “machine-readable medium” refers to any media used to provide one or more sequences of one or more instructions to the processing system 502 for execution.

Other systems, architectures, and modifications and/or reconfigurations of machine 500 of FIG. 5 are also possible. The various implementations described above have been presented by way of example only, and not limitation. For example, although portions of this disclosure discuss an IP implementation, the accelerated destination address filtering described above is applicable to many networking protocols, and a router as described herein may be a machine with minimal processing and memory capabilities and no long-term storage, or a host computer system programmed to function as a router for a wider network.

In addition, the logic flow depicted in FIG. 3 does not require the particular order shown, or that the steps be performed in sequential order. In certain implementations, multi-tasking and parallel processing may be preferable. Thus, other embodiments may be within the scope of the following claims.

What is claimed is:

1. A data routing apparatus comprising:
a network interface configurable to receive data packets;
a processor coupled with the network interface; and
a memory coupled with the processor, the memory being configured to instruct the processor to load a routing data structure configured to store information selectively indicating either a next-hop address for a received data packet or that the received data packet is to be dropped.

2. The apparatus of claim 1, wherein the routing data structure comprises one or more routing tables.

3. The apparatus of claim 2, wherein the information indicating that the received data packet is to be dropped comprises a predetermined value.

4. The apparatus of claim 2, wherein the information indicating that the received data packet is to be dropped comprises a pointer to a route entry containing a drop flag.

5. The apparatus of claim 1, wherein the stored information comprises a portion of an address field.

6. The apparatus of claim 5, wherein the address field portion comprises a network identifier.

7. The apparatus of claim 1, wherein the data packet is an Internet Protocol packet and the stored information comprises a deprecated directed broadcast address.

8. A method of configuring a data routing device comprising storing information in a routing data structure, wherein the information selectively indicates that a packet having a destination address is to be routed or dropped.

9. The method of claim 8, wherein the routing data structure comprises one or more routing tables.

10. The method of claim 9, wherein the information is a pointer to a routing record containing a drop-flag.

11. The method of claim 8, wherein a format for the destination address is defined by Internet Protocol version four.

12. The method of claim 11, wherein the destination address comprises a deprecated directed broadcast address.

13. A method comprising providing a capability for a machine to perform operations including:
comparing a destination address of a packet with routing information stored in a routing data structure, the routing information indicating that the packet either is to be routed or dropped; and
selectively routing the packet based on the routing information stored in the routing data structure.

14. The method of claim 13, wherein providing a capability for a machine to perform operations comprises providing one or more software processes capable of performing the operations on a computer system.

15. The method of claim 13, wherein a format for the destination address is defined by Internet Protocol version four.

16. The method of claim 15, wherein the destination address comprises a deprecated directed broadcast address.

17. The method of claim 13, wherein the operations further include:
counting a dropped packet; and
storing a source address and the destination address for the dropped packet.

18. A packet routing system comprising:
memory means for storing a data structure comprising a destination address routing table having entries, wherein at least one entry contains an indication that a packet having a destination address that resolves to the least one entry is to be dropped; and
processing means for receiving a packet having a destination address from a first network, for checking the destination address against the destination address routing table, and for transmitting the received packet to a second network only if the received packet does not resolve to the at least one entry.

19. The system of claim 18, wherein the destination address routing table comprises a set of tables.

20. The system of claim 19, wherein the processing means checks the destination address four bits at a time.

21. The system of claim 20, wherein the processing means transmits using Internet Protocol.

22. The system of claim 21, wherein the at least one entry corresponds to a deprecated directed broadcast address.

23. Machine-readable instructions, embodied in a machine-readable medium or a propagated signal, for causing a machine to perform operations comprising loading one or more routing tables with destination addresses and information selectively indicating either a next-hop address for a packet or that the packet is to be dropped.

24. The instructions of claim 23, wherein the information comprises:
a pointer to a route entry to indicate a next-hop address; and
a value of negative one to indicate the packet is to be dropped.

25. The instructions of claim 23, wherein the destination address comprises a network identifier.

26. The instructions of claim 25, wherein the network identifier identifies a subnet.

27. The instructions of claim 26, wherein the packet is an Internet Protocol packet.

28. The instructions of claim 27, wherein the destination address comprises a deprecated directed broadcast address.

29. The instructions of claim 28, further comprising loading the one or more routing tables with a plurality of deprecated directed broadcast addresses, one for each of a plurality of subnets, and information indicating that a packet having one of the plurality of deprecated directed broadcast addresses as its destination is to be dropped.
